(19) United States
(12) Patent Application Publication
(10) Pub. No.: US 2024/0194173 A1
(43) Pub. Date: Jun. 13, 2024

(54) METHOD, SYSTEM AND COMPUTER PROGRAM FOR GENERATING AN AUDIO OUTPUT FILE

(71) Applicant: HYPH IRELAND LIMITED, County Dublin (IE)

(72) Inventors: Max RENARD, County Dublin (IE); Anders THORSELL, County Dublin (IE)

(21) Appl. No.: 18/077,077

(22) Filed: Dec. 7, 2022

(51) Int. Cl. G10H 1/00

(52) U.S. Cl. CPC G10H 1/0025; G10H 2210/105; G10H 2220/101

(57) ABSTRACT

Techniques described herein provide a computer implemented system, method and computer program for generating an audio output file, the method including steps of: selecting a subset of instrument content blocks from a group of instrument content blocks by determining a musical style for the audio output file, in which the musical style is configured with a plurality of musical slots and each slot is associated with a predetermined musical rule, using the predetermined musical rule for each slot to select a musical template from a plurality of musical templates for the slot, in which the selected musical template defines a chord progression of successive musical chords at a musical key and tempo, selecting for each slot an instrument content block that matches the chord progression defined by the selected musical template, and generating the audio output file by combining the subset of instrument content blocks. The method provides a configuration of musical slots each designated with musical rules that determine a musical template for the audio output file. Instrument content blocks that have a chord progression matching that defined by the template are selected for use together to provide an audio output file that is harmonically pleasing to listen to. User may configure the audio output file with an arrangement of tools.

### TECHNICAL FIELD

The present disclosure relates to a method, system and computer program for generating an audio output file.

### BACKGROUND

Digital audio workstations (DAWs) have been developed to provide users with a production environment in which audio content may be composed, recorded, edited, mixed, and optionally synchronized with target image or video content.

Such DAWs are typically configured with an arrangement of tools and a library of pre-recorded audio content which users may select, edit, and combine to create an audio output file and, if desired, to synchronize the audio output file created with multimedia content, such as images and/or video files.

However, in such production environments selection by users of harmonically compatible pre-recorded audio content files for an audio output file is extremely time consuming, even for the most skilled audio editors.

It is therefore an object of the disclosure to provide a system, method and computer program for generating an audio output file that goes at least some way toward overcoming the above problems and/or provides the public or industry with a useful alternative.

Further aspects of described embodiments will become apparent from the ensuing description which is given by way of example only.

### SUMMARY

According to an embodiment, there is provided a computer implemented method for generating an audio output file including steps of:
a. selecting a subset of instrument content blocks from a group of instrument content blocks by determining a musical style for the audio output file, in which the musical style is configured with a plurality of musical slots and each slot is associated with a predetermined musical rule,
b. using the predetermined musical rule for each slot to select a musical template from a plurality of musical templates for the slot, in which the selected musical template defines a chord progression of successive musical chords at a musical key and tempo,
c. selecting for each slot an instrument content block that matches the chord progression defined by the selected musical template, and
d. generating the audio output file by combining the subset of instrument content blocks.

Embodiments provide a method and system for generating an audio output file from instrument content blocks (also referred to as stems) which when combined are harmonically compatible and thus pleasing to listen to by users.

A method provides a configuration of musical slots each designated with musical rules that determine a musical template for the audio output file.

Instrument content blocks that have a chord progression matching that defined by the template are selected for use together in the audio output file.

A system provides users with the option of generating an audio output file comprising a random selection of harmonically compatible instrument content blocks, or a selection of harmonically compatible instrument content blocks based on a user style selection (such as pop, synth, reggae, etc.) made via user interface means. Once an initial selection of harmonically compatible instrument content blocks is provided users may then apply editing and authoring tools to change, alter, adjust, shuffle and/or remove the instrument content blocks in the selection to adjust the sound audio output file und according to their preferences.

In an embodiment, each instrument content block in the group of instrument content blocks comprises a plurality of tags, wherein each tag is associated with a musical parameter of each instrument content block, and whereby the plurality of tags of an instrument content block uniquely identifies the instrument content block.

In an embodiment, each instrument content block is created by a human musician according to a musical template. Each instrument content block comprises musical content from a musical instrument.

In an embodiment, the musical style is determined according to one or more of: musical genre, musical mood, an artist name, a song title, chord progression, tempo and/or musical instruments to be involved in creating the audio output file.

In an embodiment, the method comprises a step of searching a database comprising records of artist names and song titles to determine the musical style for the audio output file.

In an embodiment, the method comprises a step of receiving an audio input file comprising at least one vocal content block, in which each vocal content block comprises a vocal performance and the audio output file is generated by combining the vocal content block and the subset of instrument content blocks. An audio output file may thus include one or a plurality of vocal content blocks.

In an embodiment, the method comprises steps of:
a. receiving an audio input file comprising a vocal performance and/or an instrument performance,
b. separating the audio input file into a vocal content block and a subset of instrument content blocks, in which the vocal content block comprises the vocal performance and each instrument content block comprises audio content from one musical instrument involved in creating the instrument performance,
c. replacing the subset of instrument content blocks with an alternative subset of instrument content blocks, and
d. generating the audio output file by combining the vocal content block with the one or more alternative instrument content blocks.

Accordingly, the present invention may receive a song from a well-known artist and, while retaining the vocal performance of the song, users may be provided with, or manually select alternative instrument content blocks in place of the original instrument performance. In this way, an audio output file in generated which retains the vocal performance of the artist but has an alternative sounding musical accompaniment which may also be adapted as desired by the user selecting alternative instrument content blocks until the user is satisfied with the sound of the final audio output file.

In an embodiment, a musical style of the audio input file is determined by analysing the vocal content block derived from the vocal performance and the alternative subset of instrument content blocks are automatically selected according to the determined musical style.

In an embodiment, a musical style of the audio input file is determined by analysing one or more of the subset of instrument content blocks derived from the instrument performance, and the alternative subset of instrument content blocks are automatically selected according to the determined musical style.

In an embodiment, the alternative subset of instrument content blocks is selected by a user operating user interface means.

In an embodiment, the method comprises steps of:
a. receiving an audio input file comprising an instrument performance,
b. separating the audio input file into instrument content blocks, in which each instrument content block comprises audio content from a musical instrument involved in creating the instrument performance,
c. determining a musical style of the audio input file by analysing the one or more instrument content blocks,
d. selecting a subset of alternative instrument content blocks according to the determined musical style such that the selected subset of alternative instrument content blocks when combined sound similar to the instrument performance in the audio output file,
e. replacing the instrument content blocks with the subset of alternative instrument content blocks and generating the audio output file by combining the selected subset of alternative instrument content blocks.

In an embodiment, the method comprises steps of operating an audio recording means by which a user records one or more audio input files.

Such audio recordings may be a vocal performance and/or an instrument performance that may be incorporated into an audio output file as one or more vocal or instrument content blocks. The audio recording means provides a selection of audio signal processors that enhance the sound of the recording for audio input files. Examples of these signal processors include reverb, delay, compressor, and pitch correction, that manipulate and enhance recordings of a vocal performance and/or an instrument performance. The audio recording(s) can be connected to a specific section or part of an audio output file and can also be duplicated (copy/paste) and used in multiple parts of the audio output file.

In an embodiment, the method comprises steps of operating a user interface means provided by a backend application programming interface (API) to create the audio output file. In operation, a native application calls the API that uses the backend audio output file generator means to create an audio output file. This process is repeated if a user changes the vocal or instrument content blocks of the audio output file or audio parameters thereof in the creation process.

In an embodiment, the present invention provides a web application that lets anyone create music with a visual interface.

The application programming interface (API) provides a central communication point to all applications that connect to the audio output file generator means. Optionally, it may be a partly open-source interface, so third parties could create music for their platform using the API.

The audio output file generator means is the core of music creation. The audio output file generator means communicates with style and template database modules to create an audio output file and uses logic entered into those modules. The audio output file generator means has built in logic to create an audio output file according to a style.

In an embodiment, the method comprises steps of operating multimedia synchronisation means to mix the audio output file with artwork, photos, videos or filtered multimedia.

In an embodiment, the method comprises operating shuffle means configured to swap an instrument content block in a slot for a different instrument content block according to the musical rule provided of the determined style.

For example if a user is listening to an audio output file with five instrument content blocks for various instruments, including one for a guitar, and the user does not like the instrument content block for the guitar, this may be shuffled or swiped such that it is removed and an alternative instrument content block that honours the slot rule of the determined style is provided in place the removed instrument content block.

In an embodiment, for instrument content blocks not having a determined pitch or key, a special tag is applied to these blocks to allow them to be used with any template at the same tempo range.

In an embodiment, the method comprises reusing existing vocal content blocks in multiple compatible templates. To provide such a feature a table relating to the musical templates is prepared by tempo (bpm), key and chord progressions, and such a table is used to locate associated templates that monophonic vocal content blocks will work with. A special tag is applied to these existing vocal content blocks which in addition to the table allows these vocal content blocks to be used in other associated templates.

In an embodiment, the method comprises a step of importing an audio input file comprising a vocal performance, converting the vocal performance to one or more vocal content blocks, tagging the vocal content blocks and using the vocal content blocks in one or more audio output files.

Such a provision will facilitate remixes and fresh arrangements of existing songs to create several different versions of well-known songs. The key component is to capture parameters of vocal performance, analyse these parameters and tag the file appropriately to allow it to work in an audio output file. Previously recorded vocal performances may also be used in the same way.

In an embodiment, the method comprises a step of changing the key for an audio output file or section thereof by replacing one or more instrument content blocks in the audio output file or section with alternative instrument content blocks in the alternative key.

In an embodiment, each template is divided into a plurality of template sections, each template section of 4 or 8 bars, whereby each template section is tagged according to its position in a section of an audio output file and template sections can be arranged in different orders. Such a configuration will give different song structures to audio output files and may be performed automatically using predetermined instructions or by the user. Different music genres may have different section arrangements. Use of manipulating sections may be used to lengthen and shorten an audio output file.

In an embodiment, the method further comprises dividing each instrument content block into sections, in which each section is a portion of the instrument content block, and the method includes muting and unmuting a section. Such a configuration is independent of a musical slot and may be performed automatically using predetermined instructions by the user.

In an embodiment, the method further comprises using the predetermined musical rule for each slot to select a plurality of musical templated for the musical slot. Such a configuration will enable an audio output file to be created from multiple template to provide a temple “mash-up”. In this way sections from different associated templates are sequenced to create a musically satisfying outcome. The table relating to the musical templates may be further utilized to find associated templates.

In an embodiment, the method further comprises providing user interface means to enable a user to change the key and tempo of an audio output file. Accordingly, they may speed up the tempo or slow it down (within a set range) and move the pitch of the audio output file up or down until they find the pitch that best suits their voice, as recorded or imported as an audio input file.

According to embodiments, there is provided a computer implemented system for generating an audio output file including:
a. means for selecting a subset of instrument content blocks from a group of instrument content blocks by means for determining a musical style for the audio output file, in which the musical style is configured with a plurality of musical slots and each slot is associated with a predetermined musical rule,
b. means for using the predetermined musical rule for each slot to select a musical template from a plurality of musical templates for the slot, in which the selected musical template defines a chord progression of successive musical chords at a musical key and tempo,
c. means for selecting for each slot an instrument content block that matches the chord progression defined by the selected musical template, and
d. means for generating the audio output file by combining the subset of instrument content blocks.

In an embodiment, tagging means is provided to tag each instrument content block in the group of instrument content blocks with a plurality of tags, wherein each tag is associated with a musical parameter of each instrument content block, and whereby the plurality of tags of an instrument content block uniquely identifies the instrument content block.

In an embodiment, each instrument content block is created by a human musician according to a musical template.

In an embodiment, the musical style is determined according to one or more of: musical genre, musical mood, an artist name, a song title, chord progression, tempo and/or musical instruments to be involved in creating the audio output file.

In an embodiment, the system comprises means for searching a database comprising records of artist names and song titles to determine the musical style for the audio output file.

In an embodiment, the system comprises means for receiving an audio input file comprising at least one vocal content block, in which the vocal content block comprises a vocal performance and the audio output file is generated by combining the vocal content block and the subset of instrument content blocks.

In an embodiment, the system comprises:
a. means for receiving an audio input file comprising a vocal performance and/or an instrument performance,
b. means for separating the audio input file into a vocal content block and a subset of instrument content blocks, in which the vocal content block comprises the vocal performance and each instrument content block comprises audio content from one musical instrument involved in creating the instrument performance,
c. means for replacing the subset of instrument content blocks with an alternative subset of instrument content blocks, and
d. means for generating the audio output file by combining the vocal content block with the one or more alternative instrument content blocks.

In an embodiment, the system comprises means for analysing the vocal content block derived from the vocal performance to determine a musical style of the audio input file and the alternative subset of instrument content blocks are automatically selected according to the determined musical style.

In an embodiment, the system comprises means for analysing one or more of the subset of instrument content blocks derived from the instrument performance to determine a musical style of the audio input file, and the alternative subset of instrument content blocks are automatically selected according to the determined musical style.

In an embodiment, the alternative subset of instrument content blocks is selected by a user operating user interface means.

In an embodiment, the system comprises:
a. means for receiving an audio input file comprising an instrument performance,
b. means for separating the audio input file into instrument content blocks, in which each instrument content block comprises audio content from a musical instrument involved in creating the instrument performance,
c. means for determining a musical style of the audio input file by analysing the one or more instrument content blocks,
d. means for selecting a subset of alternative instrument content blocks according to the determined musical style such that the selected subset of alternative instrument content blocks when combined sound similar to the instrument performance in the audio output file,
e. means for replacing the instrument content blocks with the subset of alternative instrument content blocks and generating the audio output file by combining the selected subset of alternative instrument content blocks.

In an embodiment, the system comprises audio recording means by which a user records one or more audio input files.

Such audio recordings may be a vocal performance and/or an instrument performance that may be incorporated into an audio output file as one or more vocal or instrument content blocks.

The audio recording means provides a selection of audio signal processors that enhance the sound of the recording for audio input files. Examples of these signal processors include reverb, delay, compressor, and pitch correction, that manipulate and enhance recordings of a vocal performance and/or an instrument performance. The audio recording(s) can be connected to a specific section or part of an audio output file and can also be duplicated (copy/paste) and used in multiple parts of the audio output file.

In an embodiment, the method comprises steps a user interface means provided by a backend application programming interface (API) to create the audio output file. In operation, a native application calls the API that uses the backend audio output file generator means to create an audio output file. This process is repeated if a user changes the vocal or instrument content blocks of the audio output file or audio parameters thereof in the creation process.

Embodiments provide a web application that lets anyone create music with a visual interface.

The application programming interface (API) provides a central communication point to all applications that connect to the audio output file generator means. Optionally, it may be a partly open-source interface, so third parties could create music for their platform using the API.

The audio output file generator means is the core of music creation. The audio output file generator means communicates with style and template database modules to create an audio output file and uses logic entered into those modules. The audio output file generator means has built in logic to create an audio output file according to a style.

In an embodiment, the system comprises multimedia synchronisation means to mix the audio output file with artwork, photos, videos or filtered multimedia.

In an embodiment, the system comprises shuffle means configured to swap an instrument content block in a slot for a different instrument content block according to the musical rule provided of the determined style.

For example if a user is listening to an audio output file with five instrument content blocks for various instruments, including one for a guitar, and the user does not like the instrument content block for the guitar, this may be shuffled or swiped such that it is removed and an alternative instrument content block that honours the slot rule of the determined style is provided in place the removed instrument content block.

In an embodiment, for instrument content blocks not having a determined pitch or key, a special tag is applied to these blocks to allow them to be used with any template at the same tempo range.

In an embodiment, the system comprises means for reusing existing vocal content blocks in multiple compatible templates. To provide such a feature a table relating to the musical templates is prepared by tempo (bpm), key and chord progressions, and such a table is used to locate associated templates that monophonic vocal content blocks will work with. A special tag is applied to these existing vocal content blocks which in addition to the table allows these vocal content blocks to be used in other associated templates.

In an embodiment, the system comprises means for importing an audio input file comprising a vocal performance, converting the vocal performance to one or more vocal content blocks, tagging the vocal content blocks and using the vocal content blocks in one or more audio output files.

Such a provision will facilitate remixes and fresh arrangements of existing songs to create several different versions of well-known songs. The key component is to capture parameters of vocal performance, analyse these parameters and tag the file appropriately to allow it to work in an audio output file. Previously recorded vocal performances may also be used in the same way.

In an embodiment, the system comprises means for changing the key for an audio output file or section thereof by replacing one or more instrument content blocks in the audio output file or section with alternative instrument content blocks in the alternative key.

In an embodiment, the system comprises means for dividing each template into a plurality of template sections, each template section of 4 or 8 bars, whereby each template section is tagged according to its position in a section of an audio output file and template sections can be arranged in different orders. Such a configuration will give different song structures to audio output files and may be performed automatically using predetermined instructions or by the user. Different music genres may have different section arrangements. Use of manipulating sections may be used to lengthen and shorten an audio output file.

In an embodiment, the system comprises means for dividing each instrument content block into sections, in which each section is a portion of the instrument content block, and the method includes muting and unmuting a section. Such a configuration is independent of a musical slot and may be performed automatically using predetermined instructions by the user.

In an embodiment, the system comprises means for using the predetermined musical rule for each slot to select a plurality of musical templated for the musical slot. Such a configuration will enable an audio output file to be created from multiple template to provide a temple “mash-up”. In this way sections from different associated templates are sequenced to create a musically satisfying outcome. The table relating to the musical templates may be further utilized to find associated templates.

In an embodiment, the system comprises user interface means to enable a user to change the key and tempo of an audio output file. Accordingly, they may speed up the tempo or slow it down (within a set range) and move the pitch of the audio output file up or down until they find the pitch that best suits their voice, as recorded or imported as an audio input file.

In a still further embodiment of the invention, there is provided a computer program comprising instructions that, when executed by one or more processors, cause the one or processors to perform the steps according to the method as described.

In yet another embodiment of the invention, there is provided a computing device and/or arrangement of computing devices having one or processors, memory and display means operable to display an interactive user interface having the features as described.

### BRIEF DESCRIPTION OF THE DRAWINGS

Embodiments will be more clearly understood from the following description of some embodiments thereof, given by way of example only, with reference to the accompanying drawings in which:

FIG. 1 is a block diagram showing a system for generating an audio output file according to an embodiment of the invention,

FIG. 2 is a detailed block diagram showing the use of styles and slots for selecting instrument content blocks for an audio output file according to an embodiment of the invention, and

FIG. 3 is a stylised illustration showing an embodiment of the present invention in use generating an audio output file.

### DETAILED DESCRIPTION

Embodiments of the present invention are implemented by one or more computer processors and memory including computer software program instructions executable by the one or more processors. The computer processors may be provided by a computer server or network of connected and/or distributed computers.

The audio files of the present invention, including the vocal content blocks, instrument content blocks, audio input files and audio output files, will be understood to be received, stored or recorded files containing audio or MIDI data or content which produce sound output when processed by an audio or MIDI player. Audio files may be recorded in known audio file formats, including, but not limited to, audio WAV format, MP3 format, advanced audio coding (AAC) format, Ogg format or in any other format, analog, digital or otherwise, as required. The desired audio or MIDI format may optionally be specified by a user.

A user may record one or more audio input files. Such audio recordings may be a vocal performance and/or an instrument performance that may be incorporated into an audio output file as one or more vocal or instrument content blocks.

Embodiments of the present invention provide a computer implemented system 1 for generating an audio output file 20. The system includes a generator means 10 which provides means for selecting a subset of instrument content blocks (or stems) 70, from a group of instrument content blocks (or stems) stored in a database 60. Each instrument content block comprises musical content from a musical instrument. Each instrument content block 70 is created by a human musician according to a musical template 40 which defines a chord progression of successive musical chords at a musical key and tempo that the musician must follow when creating the instrument content block 70.

The generator 10 is configured to determine a musical style 30, according to one or more parameters including musical genre 90, musical mood, an artist name, a song title, chord progression, tempo and/or musical instruments to be involved in creating the audio output file.

The musical style may be determined based on analysis of parameters of an audio input file, such as the recording of a vocal melody received from a user. Such a vocal melody is converted for inclusion as a vocal content block in an audio output file 20. The musical style for an audio output file 20 may alternatively be provided by a user selecting from a range of styles provided on user interface means 120 or may be determined by the system 1 analysing musical parameters of an audio input file initially provided by a user, such as the chord progression and tempo thereof. Optionally, users may search a database 100 comprising records of artist names and song titles to determine a musical style for the audio output file 20.

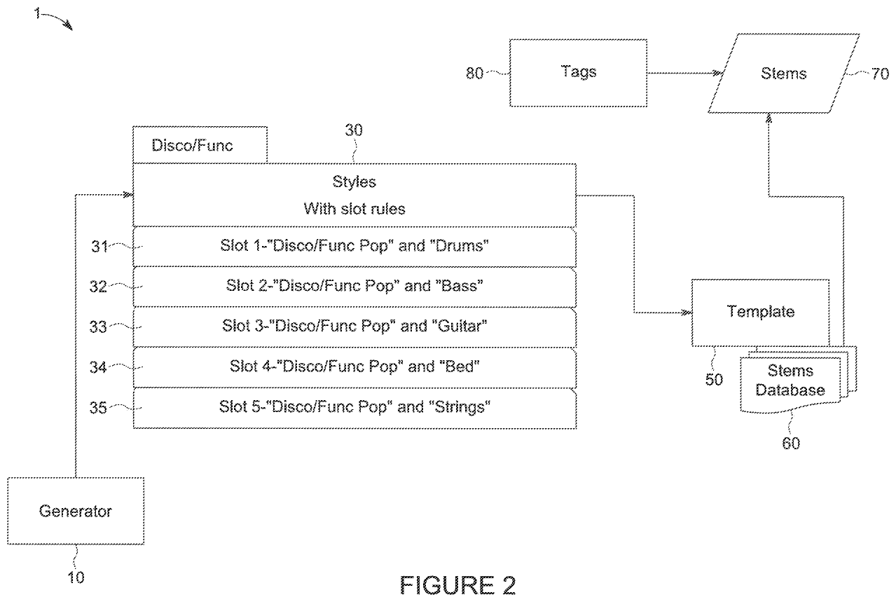

As shown in FIG. 2, a musical style 30 is configured with a plurality of musical slots 31, 32, 33, 34, 35 each associated with a predetermined musical rule. In the simplified example shown in FIG. 2, five slots are provided for the style “Disco/Func” and in each slot is a rule. Slot 1, indicated by the reference numeral 31, has the rule “Disco/Func Pop” and “Drums”, Slot 2, indicated by the reference numeral 32, has the rule “Disco/Func Pop” and “Bass” and so on for all of the five slots in the style “Disco/Func”.

The system 1 then uses the predetermined musical rules for each slot 31, 32, 33, 34, 35 to select a musical template 50 from a database 40 of musical templates for the slots, in which the selected musical template 50 defines a chord progression of successive musical chords at a musical key and tempo. The system 1 then selects for each slot 31, 32, 33, 34, 35 an instrument content block 70 from the database 60 that matches the chord progression defined in the selected musical template 50 and satisfies other rules defined for the slot and generates the audio output file 10 by combining the subset of selected instrument content blocks 70.

Tagging means 80 is provided to tag or label with identifiers each instrument content block 70, wherein each tag is associated with a musical parameter of an instrument content block 70, and the plurality of tags given to an instrument content block uniquely identifies the instrument content block 70.

For example, each instrument content block or stem 70 in the system 1 is tagged in a central tagging means by humans to describe a property of an instrument content block or stem. Samples of tags on an instrument content block or stem are shown below:

Instrument content block provider (i.e., name of the human musician)=John Doe
Key=C#
Tempo=82 bpm
Instrument=Guitar
Style=Pop
Intensity=Loud

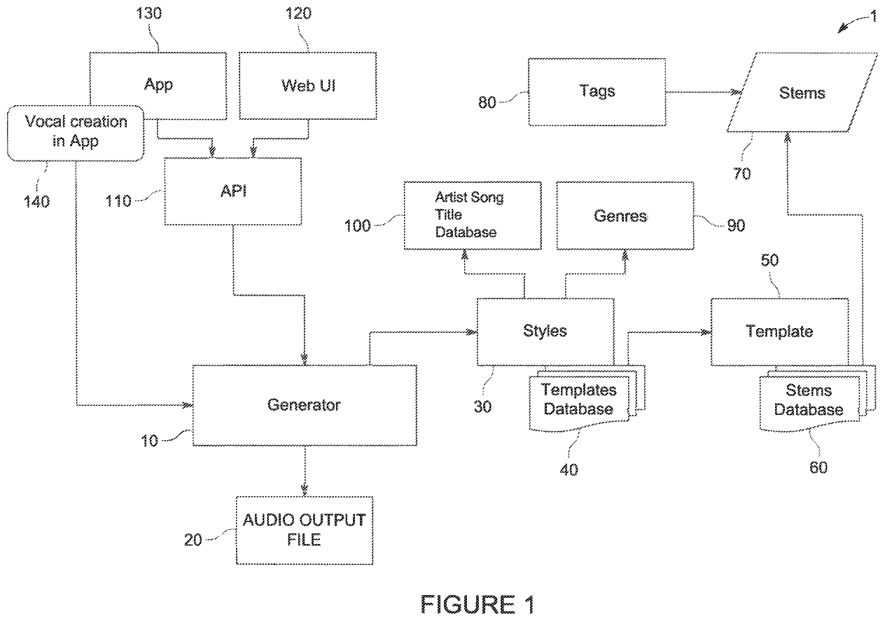

A user may additionally and optionally provide an audio input file comprising at least one vocal content block for an audio output file. Such a vocal content block comprises a vocal performance and the audio output file is generated by combining the vocal content block provided by a user and a subset of instrument content blocks 70 selected by the system 1 for the vocal content block. As shown in FIG. 1, vocal creation 140 is provided within the application and utilises recording means to enables users to sing and record their own songs for use in an audio output file.

In one application of the present invention an audio input file comprising a vocal performance and/or an instrument performance is received. The audio input file is separated into a vocal content block and instrument content blocks, in which the vocal content block comprises the vocal performance and each instrument content block comprises audio content from a musical instrument involved in creating the instrument performance.

Users may interact with the system to manually or automatically replace one or more of the instrument content blocks with an alternative subset of instrument content blocks.

In this embodiment the musical style of the audio input file is determined by analysing musical parameters of the vocal content block derived from the vocal performance and an alternative subset of instrument content blocks are automatically selected according to the musical style determined based on the parameters. Alternatively, a musical style of the audio input file is determined by analysing one or more of the subset of instrument content blocks derived from the instrument performance, and the alternative subset of instrument content blocks are automatically selected according to the determined musical style. The alternative subset of instrument content blocks may also be selected by a user operating user interface means.

The audio output file is generated by the system combining the vocal content block with the one or more alternative instrument content blocks to provide a variation of the original audio input file.

In this way the present invention may receive a song from a well-known artist and, while retaining the vocal performance of the song, users may be provided with, or manually select, alternative instrument content blocks in place of the original instrument performance that harmonically combine with the vocal performance.

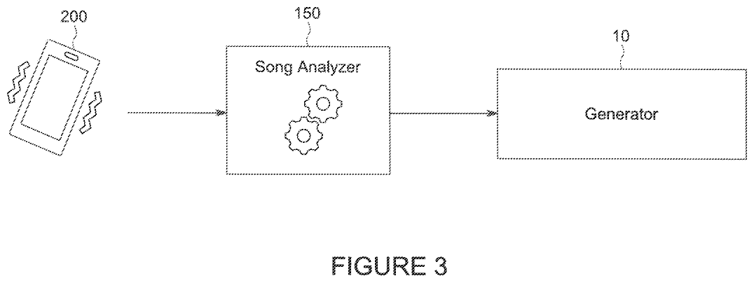

As shown in FIG. 3, the system may receive via a microphone or receiver of user electronic device 200, such as a mobile smart phone, an audio input file comprising an instrument performance. For example, a user may switch the system to listening mode in which the microphone receives as an audio input file a song or performance playing in the background.

The system by a song analyser 150 separates the audio input file into instrument content blocks 70, in which each instrument content block 70 comprises audio content from a musical instrument involved in creating the instrument performance and, together with generator 10 determines a musical style 30 of the audio input file by analysing parameters of the one or more instrument content blocks 70, such as chord progression, tempo and the like.

The generator 10 selects a subset of alternative instrument content blocks 70 according to the determined musical style 30 such that the selected subset of alternative instrument content blocks 70 when combined sound similar to the instrument performance in the audio input file.

The audio output file 20 is then created by combining the selected subset of alternative instrument content blocks 70 to generate a “soundalike”.

Embodiments may be provided by a backend application programming interface (API) 110 to create the audio output file. A software application or App 130 may be downloaded and installed on an electronic device for the display of a user interface to engage with the API 110. However, in some embodiments, the electronic device may execute a web browser application 120 which browses to a website served by a web server, wherein the user interface embedded therein is displayed.

Embodiments may provide a web application that lets anyone create music with a visual interface.

It is to be understood that the invention is not limited to the specific details described herein which are given by way of example only and that various modifications and alterations are possible without departing from the scope of the invention.

What is claimed is:

1. A computer implemented method for generating an audio output file including steps of:
selecting a subset of instrument content blocks from a group of instrument content blocks by determining a musical style for the audio output file, in which the musical style is configured with a plurality of musical slots and each slot is associated with a predetermined musical rule,
using the predetermined musical rule for each slot to select a musical template from a plurality of musical templates for the slot, in which the selected musical template defines a chord progression of successive musical chords at a musical key and tempo,
selecting for each slot an instrument content block that matches the chord progression defined by the selected musical template, and
generating the audio output file by combining the subset of instrument content blocks.

2. The method of claim 1, comprising a step of providing users with an audio output file with a random selection of harmonically compatible instrument content blocks.

3. The method of claim 1, comprising a step of providing users with an audio output file with a selection of harmonically compatible instrument content blocks based on a style selection made by a user.

4. The method of claim 1, comprising steps of:
receiving an audio input file comprising a vocal performance and/or an instrument performance,
separating the audio input file into a vocal content block and a subset of instrument content blocks, in which the vocal content block comprises the vocal performance and each instrument content block comprises audio content from one musical instrument involved in creating the instrument performance,
replacing the subset of instrument content blocks with an alternative subset of instrument content blocks, and
generating the audio output file by combining the vocal content block with the one or more alternative instrument content blocks.

5. The method of claim 4, in which the musical style of the audio input file is determined by analysing the vocal content block derived from the vocal performance and the alternative subset of instrument content blocks are automatically selected according to the determined musical style.

6. The method of claim 4, in which the musical style of the audio input file is determined by analysing one or more of the subset of instrument content blocks derived from the instrument performance, and the alternative subset of instrument content blocks are automatically selected according to the determined musical style.

7. The method of claim 4, in which the alternative subset of instrument content blocks is selected by a user operating user interface means.

8. The method of claim 1, comprising steps of:
receiving an audio input file comprising an instrument performance,
separating the audio input file into instrument content blocks, in which each instrument content block comprises audio content from a musical instrument involved in creating the instrument performance,
determining a musical style of the audio input file by analysing the one or more instrument content blocks,
selecting a subset of alternative instrument content blocks according to the determined musical style such that the selected subset of alternative instrument content blocks when combined sound similar to the instrument performance in the audio output file,
replacing the instrument content blocks with the subset of alternative instrument content blocks and generating the audio output file by combining the selected subset of alternative instrument content blocks.

9. The method of claim 1, in which the musical style is determined according to one or more of: musical genre, musical mood, an artist name, a song title, chord progression, tempo and/or musical instruments to be involved in creating the audio output file.

10. The method of claim 1, in which each instrument content block in the subset of instrument content blocks comprises a plurality of tags, wherein each tag is associated with a musical parameter of each instrument content block, and whereby the plurality of tags of an instrument content block uniquely identifies the instrument content block.

11. The method of claim 1, comprising a step of searching a database comprising records of artist names and song titles to determine the musical style for the audio output file.

12. The method of claim 1, in which the method comprises a step of receiving an audio input file comprising at least one vocal content block, in which each vocal content block comprises a vocal performance and the audio output file is generated by combining the vocal content block and the subset of instrument content blocks.

13. The method of claim 1, comprising a step of operating multimedia synchronisation means to mix the audio output file with artwork, photos, videos or filtered multimedia.

14. The method of claim 1, comprising a step of operating shuffle means configured to swap an instrument content block in a slot for a different instrument content block according to the musical rule of the determined style.

15. The method of claim 1, comprising a step of changing the key for an audio output file or section thereof by replacing one or more instrument content blocks in the audio output file or section with alternative instrument content blocks in the alternative key.

16. The method of claim 1, comprising a step of dividing each instrument content block into sections, in which each section is a portion of the instrument content block, and the method includes a step of enabling a user to mute and/or unmute sections.

17. The method of claim 1, comprising a step of providing user interface means to enable a user to change audio parameters of the audio output file.

18. A computer implemented system for generating an audio output file including:
means for selecting a subset of instrument content blocks from a group of instrument content blocks by means for determining a musical style for the audio output file, in which the musical style is configured with a plurality of musical slots and each slot is associated with a predetermined musical rule,
means for using the predetermined musical rule for each slot to select a musical template from a plurality of musical templates for the slot, in which the selected musical template defines a chord progression of successive musical chords at a musical key and tempo,
means for selecting for each slot an instrument content block that matches the chord progression defined by the selected musical template, and
means for generating the audio output file by combining the subset of instrument content blocks.

19. The system of claim 18, further comprising:
means for receiving an audio input file comprising a vocal performance and/or an instrument performance,
means for separating the audio input file into a vocal content block and a subset of instrument content blocks, in which the vocal content block comprises the vocal performance and each instrument content block comprises audio content from one musical instrument involved in creating the instrument performance,
means for replacing the subset of instrument content blocks with an alternative subset of instrument content blocks, and
means for generating the audio output file by combining the vocal content block with the one or more alternative instrument content blocks.

20. A computer program comprising instructions that, when executed by one or more processors, cause the one or processors to perform the steps according to the method of claim 1.
